(19) United States
(12) Patent Application Publication
(10) Pub. No.: US 2026/0247023 A1
(43) Pub. Date: Aug. 20, 2026

(54) INFORMATION PROCESSING APPARATUS, CONTROL METHOD THEREFOR, AND STORAGE MEDIUM

(71) Applicant: CANON KABUSHIKI KAISHA, Tokyo (JP)

(72) Inventor: REIJI HASEGAWA, Kanagawa (JP)

(21) Appl. No.: 19/535,123

(22) Filed: Feb. 10, 2026

(30) Foreign Application Priority Data
Feb. 17, 2025 (JP) 2025-023704

(51) Int. Cl. H04N 23/61; G06V 20/52; G06V 40/20; H04N 23/53; H04N 23/63

(52) U.S. Cl. CPC H04N 23/61; G06V 20/52; G06V 40/23; H04N 23/53; H04N 23/633

(57) ABSTRACT

An information processing apparatus includes an acquisition unit that acquires a captured image, a subject detection unit that detects a specific subject registered in advance from the image, an action detection unit that detects a specific action of a specific subject from the image; and a management unit that manages information on a specific subject acquired by the acquisition unit. The management unit records an identifier of a specific subject taking the specific action and a count of recording an image of the specific subject taking the specific action, in a case where shooting of the specific subject taking the specific action is performed.

### BACKGROUND

### Field of the Technology

The present disclosure relates to an information processing apparatus that has a subject detection function.

### Description of the Related Art

As work of a professional photographer, there is a demand for shooting a plurality of players who are coverage targets or all team members who are coverage targets in shooting of team sports. It is not enough to simply take their photographs; it is desired to shoot sports highlights, as well as specific scenes and postures. A plurality of highlight scenes are also necessary for each player who is a coverage target. The number of shot highlight scenes of the subject necessary for such coverage is called a "yield" in the television and camera industries. In the work of a sports photographer, securing of a yield is most important.

The photographer masters many pieces of equipment, has a very wide variety of things to think about, such as positioning and the flow of the game, and may have difficulty in remembering the yield of each of a plurality of players. Therefore, it is desired that a camera provide some kind of automatic support therefor.

In Japanese Patent Laid-Open No. 2020-174311, an area of an individual's face and the number of appearances are counted with scores in a series of shooting so that each person can be uniformly shot. However, the technique disclosed in Japanese Patent Laid-Open No. 2020-174311 is effective in an event such as a field trip, but it is not the case in professional sports photographs that it is good enough as long as the face appears. As described above, a yield for highlight scenes of all the players who are coverage targets or the like is necessary.

### SUMMARY

The present disclosure has been made in view of the above-described problems, and provides an image capturing apparatus that can improve yield for each person in a case of shooting a plurality of persons.

According to the present disclosure, there is provided an information processing apparatus comprising: at least one processor or circuit and a memory storing instructions to cause the at least one processor or circuit to perform operations of the following units: an acquisition unit that acquires a captured image; a subject detection unit that detects a specific subject registered in advance from the image; an action detection unit that detects a specific action of a specific subject from the image; and a management unit that manages information on a specific subject acquired by the acquisition unit, wherein the management unit records an identifier of a specific subject taking the specific action and a count of recording an image of the specific subject taking the specific action, in a case where shooting of the specific subject taking the specific action is performed.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram illustrating a configuration of a digital camera of an interchangeable lens type that is a first embodiment of an image capturing apparatus of the present disclosure.

FIG. 2 is a flowchart showing an operation of live view processing.

FIGS. 3A to 3J are views illustrating examples of joint detection and action detection.

FIG. 4 is a flowchart showing an operation of processing of recording a person list.

FIGS. 5A to 5C are views illustrating record examples of person lists.

FIG. 6A to 6E are views illustrating display examples of person lists.

FIGS. 7A to 7F are views illustrating connection examples and operation examples using a network of a plurality of cameras.

FIGS. 8A to 8C are views illustrating record examples of person lists in a plurality of cameras.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

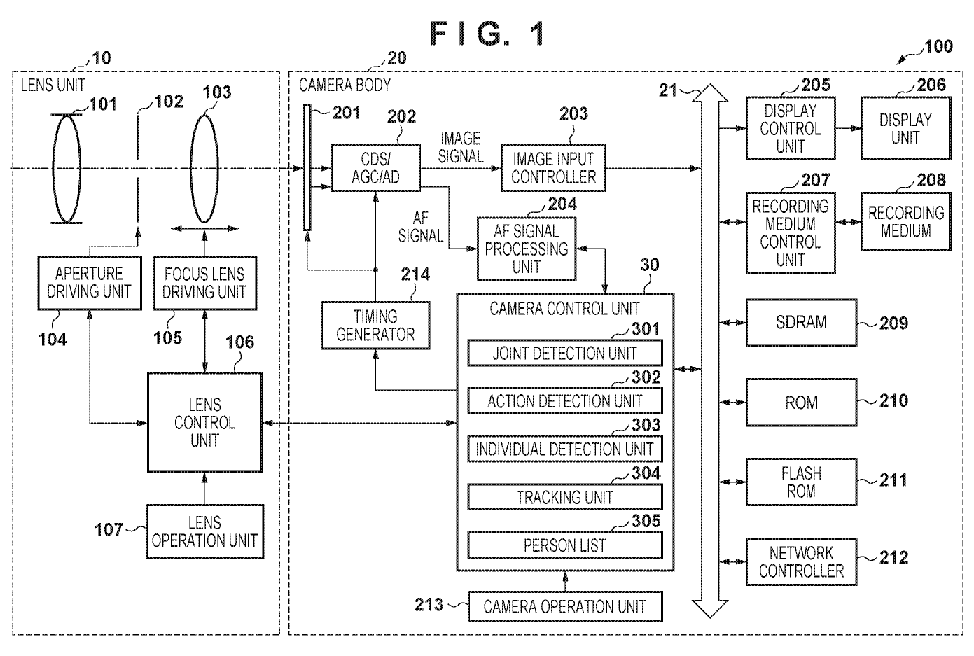

FIG. 1 is a block diagram illustrating a configuration of a digital camera 100 of an interchangeable lens type, which is a first embodiment of an image capturing apparatus of the present disclosure.

The digital camera 100 of the present embodiment includes a lens unit 10, which is interchangeable, and a camera body 20. A lens control unit 106 that supervises and controls the operation of the entire lens and a camera control unit 30 that supervises the operation of the entire camera system including the lens unit 10 can communicate with each other through a terminal provided on a lens mount.

First, the configuration of the lens unit 10 will be described. A fixed lens 101, an aperture 102, and a focus lens 103 constitute a shooting optical system. The aperture 102 is driven by an aperture driving unit 104 and controls the incident light quantity on an image capturing element 201 described later. The focus lens 103 is driven by a focus lens driving unit 105, and the focal distance of the shooting optical system varies according to the position of the focus lens 103. The aperture driving unit 104 and the focus lens driving unit 105 are controlled by the lens control unit 106, and the opening amount of the aperture 102 and the position of the focus lens 103 are determined.

A lens operation unit 107 is an input device group for a user to perform settings regarding the operation of the lens unit 10, such as switching between an autofocus (AF) mode and a manual focus (MF) mode, position adjustment of the focus lens by the MF, operation range setting of the focus lens, and setting of a camera shake correction mode. In a case where the lens operation unit 107 is operated, the lens control unit 106 performs control in accordance with the operation.

The lens control unit 106 controls the aperture driving unit 104 and the focus lens driving unit 105 in accordance with a control command or control information received from the camera control unit 30 described later, and transmits lens control information to the camera control unit 30.

Next, the configuration of the camera body 20 will be described. The camera body 20 is configured to be able to acquire an image signal from a light flux passing through the shooting optical system of the lens unit 10.

The image capturing element 201 includes a CCD or a CMOS sensor. A light flux incident from the shooting optical system of the lens unit 10 forms an image on a light receiving surface of the image capturing element 201, and is converted into a signal charge in accordance with the incident light quantity by photodiodes provided in pixels arrayed in the image capturing element 201. The signal charge accumulated in each photodiode is sequentially read from the image capturing element 201 as a voltage signal in accordance with the signal charge by a drive pulse output from a timing generator 214 in response to a command of the camera control unit 30.

A CDS/AGC/AD converter 202 performs correlated double sampling for removing reset noise, gain adjustment, and AD conversion on the image signal read from the image capturing element 201. The CDS/AGC/AD converter 202 outputs the image signal and the AF signal subjected to the processing to an image input controller 203 and an AF signal processing unit 204, respectively.

The image input controller 203 stores, as an image signal, into an SDRAM 209 via a bus 21, the image signal output from the CDS/AGC/AD converter 202. The image signal stored in the SDRAM 209 is read by a display control unit 205 via the bus 21 and displayed on a display unit 206. The display unit 206 may be configured by installing a panel-shaped display apparatus such as liquid crystal or organic EL in the camera body 20, or may be configured by installing a small display apparatus so as to be looked into from a viewfinder.

In a recording mode for performing recording of image signals, the image signal stored in the SDRAM 209 is recorded in a recording medium 208 such as a semiconductor memory by a recording medium control unit 207.

A ROM 210 stores a control program and a processing program to be executed by the camera control unit 30, various types of data necessary for execution of them, and the like. A flash ROM 211 stores various types of setting information and the like regarding the operation of the camera body 20 set by the user.

A network controller 212 is a network controller using wired communication or wireless communication. The digital camera 100 can be connected to a server via a network. A plurality of the digital cameras 100 may be mutually connected.

The camera control unit 30 includes, as function modules, a joint detection unit 301, an action detection unit 302, an individual detection unit 303, a tracking unit 304, and a person list 305. In the present embodiment, these function modules are implemented by the camera control unit 30 executing a control program stored in the ROM 210, but may be configured by independent circuits.

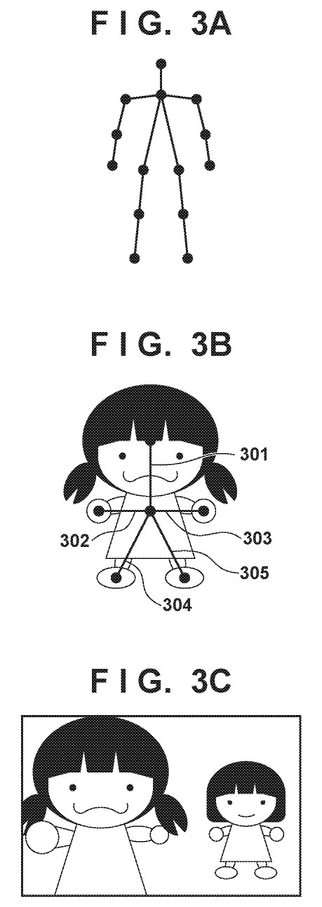

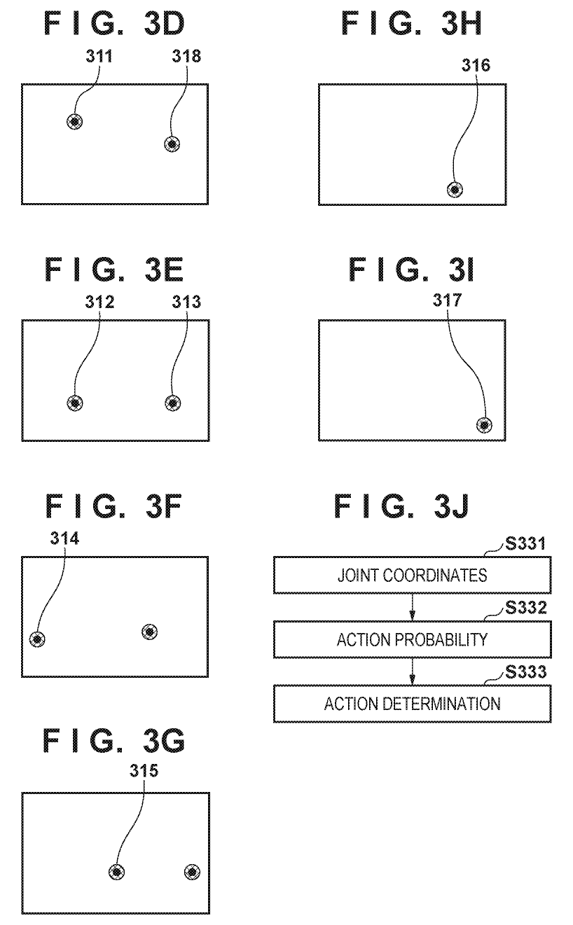

The joint detection unit 301 detects and stores, as in FIGS. 3D to 3I described later, each joint or an organ of a target person, or an object worn on or held in the hand of the person in the image signal input from the image input controller 203. Available detection methods include a known method using a neural network, a decision tree, or another machine learning model.

Using the joint information output from the joint detection unit 301 as input, the action detection unit 302 infers whether or not the target person is taking a specific action. The specific action is, for example, an action of swinging a racket in tennis shooting or a shooting action in soccer shooting. More specifically, the specific action is detected based on the posture of the target person or an object related to the specific action such as a racket or a ball. In a case where different types of events in sports or the like are shot, the action detection unit 302 may switch to another algorithm, or may replace parameters or weights of the neural network by using an identical algorithm.

The individual detection unit 303 first registers one or more persons in advance. At that time, a person ID (identifier) for each person is assigned. Then, it is determined (authenticated) whether or not the person in the image signal input from the image input controller 203 is identical to the person registered in advance, and if it is the identical person, the coordinates and the ID are output.

The tracking unit 304 detects the same subject as the subject selected in the previous frame from the image signal input from the image input controller 203, and outputs the coordinates and the person ID.

Although the individual detection unit 303 and the tracking unit 304 are similar, the individual detection unit 303 detects a person registered in advance, whereas the tracking unit detects a subject selected in a previous frame.

Although detailed control will be described later, the person list 305 records the number of times an action is detected and shot, coordinates, and the like for each person ID detected in each of the modules 301 to 304, and details of the control will be described later.

Available detection methods in each of these modules 301 to 304 include a neural network, a decision tree, or another machine learning model, or a simple rule-based algorithm.

The camera control unit 30 controls the respective units in the camera body 20 while exchanging information with them. In response to an input from a camera operation unit 213 based on a user operation, the camera control unit 30 executes various types of processing corresponding to the user operation, such as ON/OFF of a power supply, change of various settings, image capturing processing, AF processing, and reproduction processing of a recorded image. Furthermore, the camera control unit 30 transmits, to the lens control unit 106, a control command for the lens unit 10 (lens control unit 106) and information on the camera body 20, and acquires information on the lens unit 10 from the lens control unit 106. The camera control unit 30 is constituted by a microcomputer, and controls the entire camera system including the lens unit 10, which is interchangeable, by executing a computer program stored in the ROM 210.

Hereinafter, the processing performed by the camera body 20 will be described. The camera control unit 30 performs the following processing in accordance with an image capturing processing program, which is a computer program.

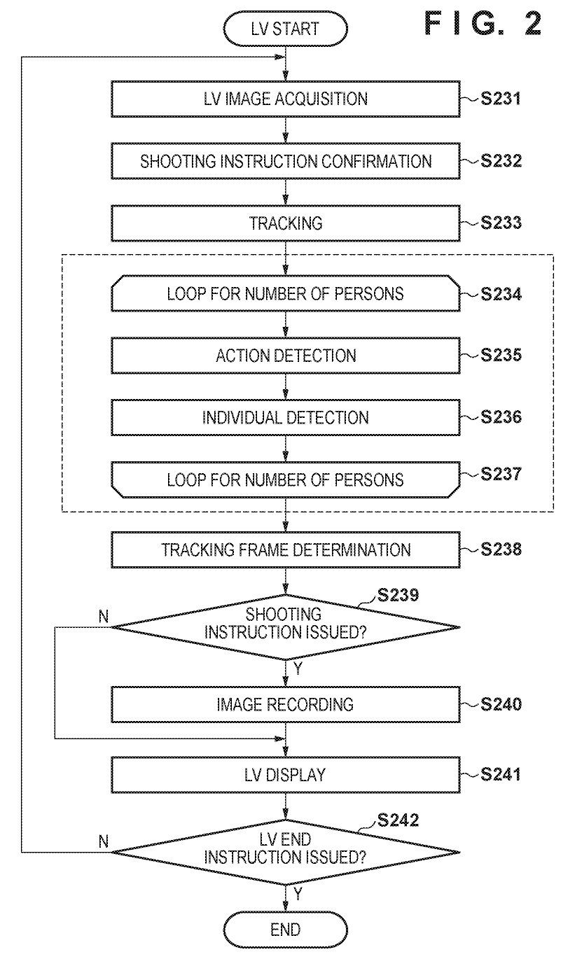

FIG. 2 is a flowchart showing an operation procedure of live view (abbreviated as LV in the drawings and the like) of the camera body 20. S means a step.

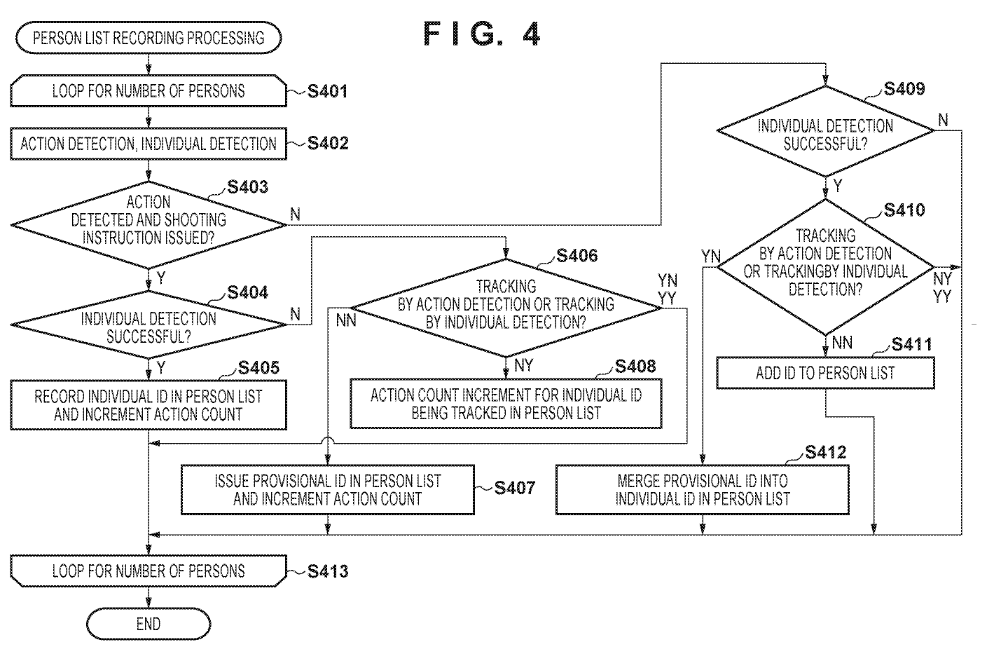

A method of recording, into the person list 305, a person who takes a specific action according to later-described S234 to S237 and processing for determining a tracking subject will be described later with reference to FIG. 4.

The processing after live view is started by the camera operation unit 213 in the camera body 20 will be described.

In S231, the camera control unit 30 acquires a live view image.

In S232, the camera control unit 30 confirms whether or not the shooting operation is instructed by pressing of the release button or the like in the camera operation unit 213. The actual shooting operation is performed in S240.

In S233, the camera control unit 30 searches for the subject tracked in the previous frame from the image and acquires coordinates.

In S234, the camera control unit 30 detects a person in the image, and repeats the subsequent processing for the number of detected persons.

In S235, the camera control unit 30 determines whether the person takes a specific action by the action detection unit 302. Recording is performed in the person list as necessary.

In S236, the camera control unit 30 determines, by the individual detection unit 303, whether the person is identical to the person registered in advance. Recording is performed in the person list as necessary.

In S237, the camera control unit 30 repeats the processing from S234 to S237 for the number of persons detected in S234.

In S238, the camera control unit 30 determines the subject to track in the next live view image by the processing from S234 to S237.

In S239, the camera control unit 30 checks whether or not shooting is instructed by the user pressing the release button or the like in S232. If shooting is instructed, the process proceeds to S240, and if not, the process proceeds to S241.

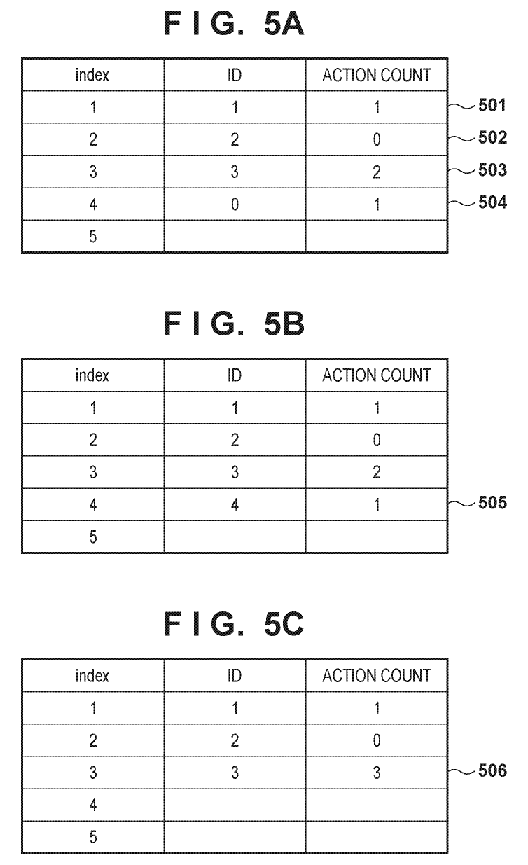

In S240, the camera control unit 30 performs shooting processing. In the person list 305, the action count is recorded under the ID of a person who is currently taking a specific action. Details will be described with reference to FIGS. 4 and 5A to 5C.

In S241, the camera control unit 30 superimposes a frame on the current tracking subject in the LV image to display it on the display unit 206.

In S242, the camera control unit 30 checks whether or not an instruction to end live view is issued by the user using the camera operation unit 213. If an end instruction is issued, this series of processing is ended. If no instruction is issued, the process returns to S231, and S231 to S242 are repeated.

How a joint is detected and connected by the joint detection unit 301 and how a specific action is detected by the action detection unit 302 will be described with reference to FIGS. 3A to 3I.

In posture estimation, it is common to detect, as in FIG. 3A, 14 points of the head, the neck, the left and right shoulders, the left and right elbows, the left and right wrists, the left and right hip joints, the left and right knees, and the left and right ankles. Note that in this case, there are 13 connections of joints.

In order to prevent the illustration from becoming complicated and difficult to see, the present embodiment assumes six joints of the head, the center of gravity, the left and right hands, and the left and right feet as in FIG. 3B, but the 14 joints or the like are detected in a case of implementation.

For example, it is assumed that an image as in FIG. 3C is input to the joint detection unit 301. Then, a reaction of the head appears as 311 of FIG. 3D. Similarly, the center of gravity appears as 312 of FIG. 3E, the right hand as 314 of FIG. 3F, the left hand as 315 of FIG. 3G, the right foot as 316 of FIG. 3H, and the left foot as 317 of FIG. 3I.

As in FIG. 3B, five connections of a connection 301 between the head and the center of gravity, a connection 302 between the right hand and the center of gravity, a connection 303 between the left hand and the center of gravity, a connection 304 between the right foot and the center of gravity, and a connection 305 between the left foot and the center of gravity are necessary as the paths for connecting the joints.

For example, assuming that there is a reaction of two heads of 311 and 318 as in FIG. 3D, there are two persons in the screen in this case, and therefore, the loop of S204 to S207 of FIG. 2 is processed twice.

In the first loop, in a case where a connection is made from the head 311 to the center of gravity, there are two candidates of 312 and 313 of FIG. 3E. In this connection, the point 312 is selected using some known algorithm such as selecting one with the shorter distance. This completes one connection between the head and the center of gravity. Similarly, in the case of five joints, this is repeated for five connections, and the connection is completed as in FIG. 3B.

FIG. 3J shows the flow up to action detection.

In S331, the camera control unit 30 infers the joint coordinates of each person in the screen in the above flow using the joint detection unit 301.

In S332, the camera control unit 30 inputs the joint coordinates to the action detection unit 302. As described above, since the action detection unit 302 is a machine learning model, it infers whether or not it is a specific action and outputs the inference result with a probability.

In S333, the camera control unit 30 determines that a specific action has occurred in a case where the probability output from the action detection unit 302 exceeds a predetermined threshold, and determines that the specific action has not occurred in a case where the probability does not exceed the predetermined threshold.

In the present embodiment, the threshold is a fixed value. A case where the threshold is variable will be described later.

The present embodiment assumes classification with two classes of being a specific action or not, but may be designed to detect a plurality of actions.

The method of recording into the person list 305 in S234 to S237 will be described with reference to FIGS. 4 and 5A to 5C.

In S401, the camera control unit 30 detects all the persons in the image, selects one person in order from all the persons, and repeats the subsequent processing for the number of persons.

In S402, the camera control unit 30 detects the action of the person selected in S401 using the action detection unit 302, and authenticates, by the individual detection unit 303, whether the person selected in S401 is a person registered in advance.

In S403, the camera control unit 30 determines whether or not the person selected in S401 takes a specific action and a shooting instruction is issued in S232. In a case where the person takes a specific action and a shooting instruction is issued, the tracking unit 304 starts tracking the person, and the process proceeds to S404. Otherwise, the process proceeds to S409.

In S404, the camera control unit 30 determines whether or not the person whose specific action is detected in S403 is determined in S402 to match the person registered in advance. If it is the person registered in advance, tracking by the tracking unit 304 is continued, and the process proceeds to S405. Otherwise, the process proceeds to S406.

In S405, since the person whose specific action is detected by the action detection unit 302 matches the person detected by the individual detection unit 303, the camera control unit 30 records the ID of the person into the person list 305 as indicated by 501 of FIG. 5A. Since the shooting instruction is issued in S232, the action count (shooting count) of the person is incremented by 1 and recorded.

In S406, the camera control unit 30 determines whether tracking is being performed by action detection (S403) or tracking is being performed by individual detection (S404 or S409) in the previous frame. The process proceeds to S407 if neither is true, the process proceeds to S408 if the tracking is performed not by action detection but by individual detection, and the process proceeds to S413 otherwise.

In S407, since a specific action is detected by the action detection unit 302 in S403 for an unknown person, the camera control unit 30 records a provisional ID (let the provisional ID be 0) in the person list 305 as 504 of FIG. 5A. Since the shooting is performed by the shooting instruction in S232, the action count (shooting count) of the person is incremented by 1 and recorded.

In S408, since the action detection unit 302 detects a specific action for the person being tracked by the tracking unit 304 and a shooting instruction is issued in S232, the camera control unit 30 increments the action count (shooting count) by 1 and records it in the field for the ID of the person being tracked in the person list 305.

For example, in a case where 503 of FIG. 5A initially has index 3, ID 3, and action count 1, the action count is increased to 2 as in FIG. 5A.

In S409, the camera control unit 30 determines whether or not the person selected in S401 is a person registered in advance. If it is the person registered in advance, tracking by the tracking unit 304 is started, and the process proceeds to S410. Otherwise, the process proceeds to S413.

In S410, the camera control unit 30 determines whether tracking is being performed by action detection (S403) or tracking is being performed by individual detection (S404 or S409) in the previous frame. The process proceeds to S411 if neither is true, the process proceeds to S412 if the tracking is performed by action detection and not by individual detection, and the process proceeds to S413 otherwise.

In S411, the camera control unit 30 records the ID of the person selected in S401 and detected by the individual detection unit 303 in S409 into the person list 305 as 502 of FIG. 5A, and, since no action has been detected yet, records the action count without increasing it.

In S412, in a case where the individual detection unit 303 successfully detects the person ID of the person being tracked by the tracking unit 304 and the ID is not in the person list, the camera control unit 30 performs as follows. For example, in a case where the person with the provisional ID currently being tracked of 504 of FIG. 5A is found as ID 4, the ID is updated to 4 and recorded as 505 of FIG. 5B.

In a case where the ID is in the person list, the following is performed. For example, in a case where the person with the provisional ID currently being tracked of 504 of FIG. 5A is found as ID 3, index 3 (503) and index 4 (504) are deleted, and an integrated index 3, ID 3, and the action count 3 = (2 + 1) are updated and recorded as 506 of FIG. 5C.

In S413, the camera control unit 30 loops S401 to S413 for the number of persons in the image.

As described above, when individual detection and action detection are simultaneously performed, they will be logged. If action detection is performed in the next or subsequent frame after individual detection, the action count of the person with the detected ID is increased. If the person being tracked takes a specific action after action detection, the provisional ID is made an official ID or integrated with an existing ID.

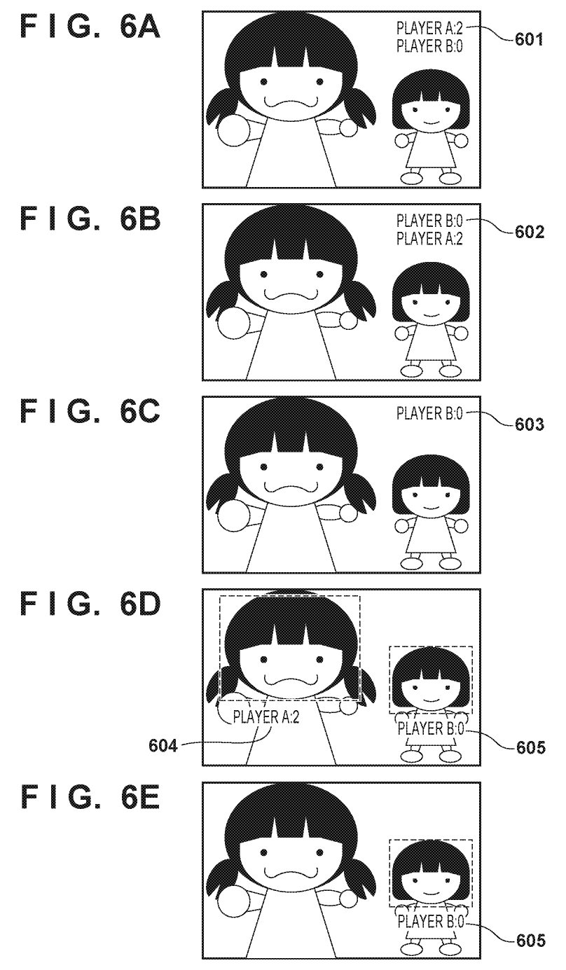

Next, a display example of the person list 305 onto the display unit 206 will be described with reference to FIGS. 6A to 6E.

The action count for each person ID recorded in the person list 305 is the number of shot images of each person taking a specific action, under the control described so far. By presenting the photographer (user) (notifying the photographer (user) of) this number of shot images in real time, the yield can be managed, and a guideline of the subject to be shot can be obtained.

FIG. 6A illustrates an example of yield display. As reference numeral 601, the current yield is displayed for all the persons registered in advance in the individual detection unit 303. In this case, it is found that the yield of a player B is low.

In a case of the example of FIG. 6D, displaying (highlighting) frames (604 and 605) on the registered person in the image, and directly describing the yield in the person frame can support shooting of the professional photographer in a more intuitive and easy-to-understand manner.

As described above, according to the present embodiment, it is possible to shoot each person while viewing the yield of each person on a display member, it is possible to manage the yield, and it is possible to obtain a shooting guideline.

### Second Embodiment

In the second embodiment, the description of identical configurations and control to those of the first embodiment will be omitted, and different parts will be described.

Here, two examples of a method for defining a person with a small yield will be described.

For example, in FIG. 5B, persons registered in advance are four persons of IDs 1 to 4. Here, the average of the action count is calculated as (1 + 0 + 2 + 1)/4 = 1. Then, the person whose count is less than the average is ID 2, and it is found to be necessary to increase the yield for this person.

It is also conceivable to set a yield per person in the camera body 20 using the camera operation unit 213 in advance. If the yield per person is set to one in advance and the current situation is as FIG. 5B, it is found that ID 2 is to be shot with higher priority.

A display example on the display unit 206 at this time will be described with reference to FIGS. 6A to 6E.

FIG. 6B is an example of yield display. As reference numeral 602, the current yield is displayed for all the persons registered in advance in the individual detection unit 303. At this time, since the player B, whose yield is less than the average, is to be shot with higher priority, the player B is displayed at a higher level for easier viewing.

FIG. 6C is an example of yield display. As reference numeral 603, only the player B, whose yield is less than the average, is displayed, and the player to be shot with higher priority is made easier to view.

FIG. 6E is an example of yield display. As reference numeral 605, a person frame is superimposed on the player B, whose yield is less than the average, and the yield is further displayed thereon if necessary. A player to be shot with higher priority is made easier to view.

As described above with reference to FIG. 3J, the action probability output in S332 is provided with a threshold, and action determination is performed. At this time, it is conceivable to lower the threshold of an action determination of a person with a small yield or raise the inference probability.

This facilitates the action determination in S403, and facilitates tracking. Shooting during tracking further increases the yield.

On the contrary, if the yield of the person under action determination is sufficient and there is another person whose yield is below the average, a method for increasing the threshold or discounting the inference probability may be used.

As described above, according to the second embodiment, it is possible to shoot a person with a small yield while checking with the display member, and it is possible to obtain a shooting guideline. It is easy to detect the action of a person with a low yield, and the yield is improved as compared with normal shooting.

### Third Embodiment

In the third embodiment, the description of identical configurations and control to those of the first embodiment will be omitted, and different parts will be described.

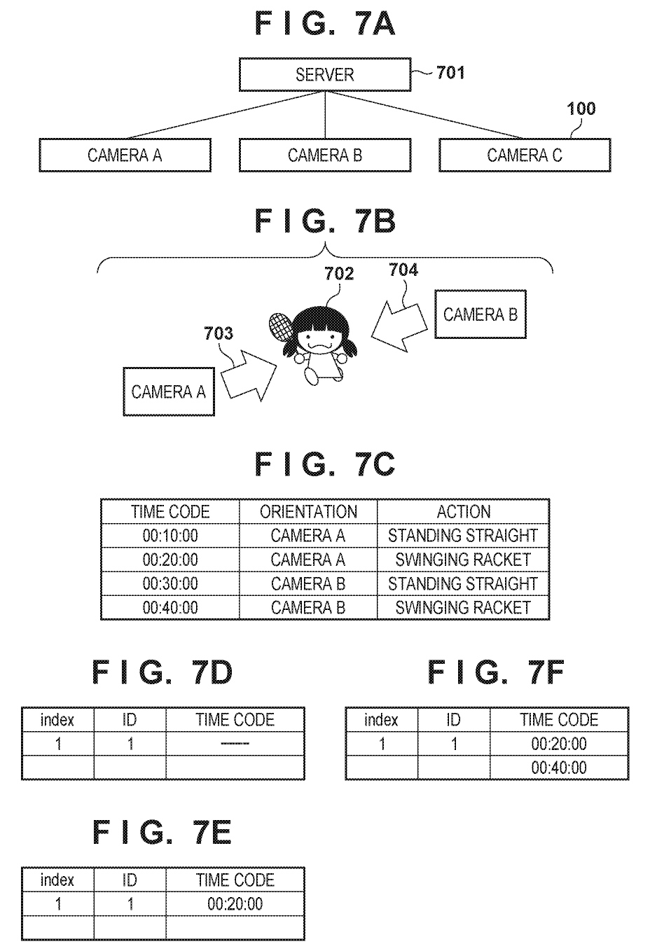

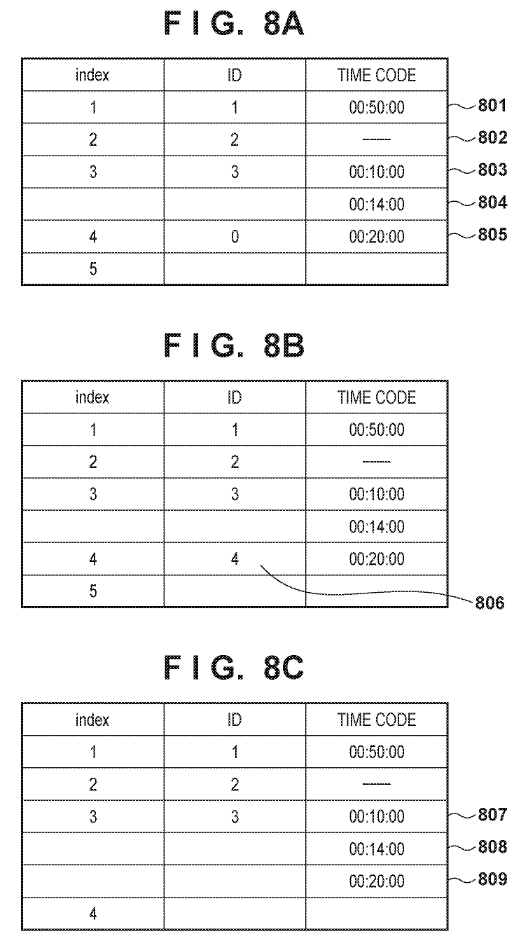

FIG. 7A is a view of a plurality of the digital cameras 100 connected to a server through a network. Instead of each of the digital cameras 100 individually possessing the person list 305, the server 701 possesses one. At this time, the person list 305 describes not an action count but a time code (time information) for each individual action as in FIG. 8A. Therefore, in a case where it is desired to know the action count, the number of the described time codes is counted.

Regarding a method of recording into the person list 305 in S234 to S237 of FIG. 2, a case of operating with a plurality of cameras will be described with reference to FIG. 4 and FIGS. 8A to 8C.

Since there is no change in the flowchart itself, the same FIG. 4 is used. It is assumed that the time codes are shared among a plurality of cameras.

In FIG. 4, in S401, the camera control unit 30 detects all the persons in the image, selects one person in order from all the persons, and repeats the subsequent processing for the number of persons.

In S402, the camera control unit 30 detects the action of the person selected in S401 using the action detection unit 302, and authenticates, by the individual detection unit 303, whether the person selected in S401 is a person registered in advance.

In S403, the camera control unit 30 determines whether or not the person selected in S401 takes a specific action and a shooting instruction is issued in S232. In a case where the person takes a specific action and a shooting instruction is issued, the tracking unit 304 starts tracking the person, and the process proceeds to S404. Otherwise, the process proceeds to S409.

In S404, the camera control unit 30 determines whether or not the person whose specific action is detected in S403 is determined in S402 to match the person registered in advance. If it is the person registered in advance, tracking by the tracking unit 304 is continued, and the process proceeds to S405. Otherwise, the process proceeds to S406.

In S405, since the person whose specific action is detected by the action detection unit 302 matches the person detected by the individual detection unit 303, the camera control unit 30 records the ID of the person into the person list 305 as indicated by 801 of FIG. 8A. Specifically, the ID of the person and the time code in which the action is detected are recorded.

In S406, the camera control unit 30 determines whether tracking is being performed by action detection (S403) or tracking is being performed by individual detection (S404 or S409) in the previous frame. The process proceeds to S407 if neither is true, the process proceeds to S408 if the tracking is performed not by action detection but by individual detection, and the process proceeds to S413 otherwise.

In S407, since a specific action is detected by the action detection unit 302 in S403 for an unknown person, the camera control unit 30 records a provisional ID (let the provisional ID be 0) and a current time code in the person list 305 as 805 of FIG. 8A.

In S408, since the action detection unit 302 detects a specific action for the person being tracked by the tracking unit 304 and a shooting instruction is issued in S232, the camera control unit 30 increments the action count (shooting count) by 1 and records it in the field for the ID of the person being tracked in the person list 305.

As an example, assuming that 803 of FIG. 8A initially describes index 3, ID 3, and one time code based on one previous action, the current time code is added as indicated by 804.

In S409, the camera control unit 30 determines whether or not the person selected in S401 is a person registered in advance. If it is the person registered in advance, tracking by the tracking unit 304 is started, and the process proceeds to S410. Otherwise, the process proceeds to S413.

In S410, the camera control unit 30 determines whether tracking is being performed by action detection (S403) or tracking is being performed by individual detection (S404 or S409) in the previous frame. The process proceeds to S411 if neither is true, the process proceeds to S412 if the tracking is performed by action detection and not by individual detection, and the process proceeds to S413 otherwise.

In S411, the camera control unit 30 records the ID of the person selected in S401 and detected by the individual detection unit 303 in S409 into the person list 305 as 802 of FIG. 8A, and, since no action has been detected yet, the time code is left blank.

In S412, in a case where the individual detection unit 303 successfully detects the person ID of the person being tracked by the tracking unit 304 and the ID is not in the person list, the camera control unit 30 performs as follows. For example, in a case where the person with the provisional ID currently being tracked of 805 of FIG. 8A is found as ID 4, 4 is recorded in the ID as 806 of FIG. 8B.

In a case where the ID is in the person list, the following is performed. For example, in a case where the person with the provisional ID currently being tracked of 803 of FIG. 8A is found as ID 3, time code 809 is recorded at index 3, ID 3 to already existing time codes 807 and 808, as in FIG. 8C.

As described above, when individual detection and action detection are simultaneously performed, they are logged. If action detection is performed in the next or subsequent frame after individual detection, the action count of the person with the detected ID is increased. If the person being tracked takes a specific action after action detection, the provisional ID is made an official ID or integrated with an existing ID.

An example of shooting by a plurality of cameras will be described with reference to FIGS. 7B to 7F.

It is assumed that a subject 702 is playing tennis and one of actions to be detected is "swinging a racket".

FIG. 7B illustrates a positional relationship between the camera and the subject, and it is assumed that the subject 702 is shot by two cameras A and B. The camera A is oriented as 703, and is in front of the subject 702. The camera B is oriented as 704, and is at the back of the subject 702.

FIG. 7C illustrates an example of the play of the subject 702, and it is assumed that the subject 702 faces the designated camera and takes an action at each time code.

FIGS. 7D to 7F are the person list 305 shared by the server 701, which is an example in the play of FIG. 7C.

At Time Code 00:10:00 in FIG. 7C

When viewed from the camera A, the subject 702 is standing straight but the face is visible, and therefore the subject 702 is detected as the player of ID 1 by individual detection. Since the subject is standing straight, no action detection is performed, the person list 305 is recorded as in FIG. 7D, and tracking is started. This corresponds to the processing of S411. When viewed from the camera B, the subject 702 is standing straight and showing her back, and neither individual detection nor action detection is responding.

At Time Code 00:20:00 in FIG. 7C

When viewed from the camera A, the subject 702 that is being tracked is swinging a racket, and therefore the action of the player of ID 1 is detected, and the time code is recorded in index 1 as in FIG. 7E for the person list 305. This corresponds to the processing of S408. When viewed from the camera B, the subject 702 shows her back but is swinging the racket, and therefore action detection is performed and the processing of S407 is to be performed. However, as in FIG. 7E, since the action of the same time code is already described, the entry into the person list 305 in the processing of S407 is canceled.

At Time Code 00:30:00 in FIG. 7C

When viewed from the camera A, the subject 702 that is being tracked shows her back and is standing straight, and tracking of the player of ID 1 is continued. When viewed from the camera B, the subject 702 is standing straight in front, so that the individual detection unit 303 detects the subject as the player of ID 1. Since the subject is standing straight, no action detection is performed, and the subject is to be entered into the person list 305, but the entry is canceled because ID 1 already exists. This corresponds to the processing of S411.

At Time Code 00:40:00 in FIG. 7C

When viewed from the camera A, the subject 702 shows her back and is swinging the racket. If tracking is successful, the subject is found as the subject of ID 1, but in order to increase the variation of the example, it is assumed here that tracking cannot be performed due to separation from the camera or the like. Then, the processing to the person list 305 does not occur in the camera A.

When viewed from the camera B, the subject 702 is swinging the racket in front. The tracking is already being performed as ID 1, the action is detected, and the time code is entered under index 1 and ID 1 as in FIG. 7F. Since the time code is different from 00:20:00, which is the previous action, the action is entered as the second action.

Doing this enables the person list 305 to be shared by the plurality of cameras. Even if an action is simultaneously detected by a plurality of cameras, it is possible to avoid duplication by the time code. Even if one camera loses sight of the subject, another camera can detect it, and the action of the person of the same ID can be counted. It is possible to perform yield management also when one game is shot by a plurality of cameras or a team of a plurality of photographers.

As described above, according to the third embodiment, the effects of the first and second embodiments can be shared not only by one camera but also by a plurality of cameras, and it is possible to achieve yield management as a team and improvement of the yield.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-023704, filed February 17, 2025, which is hereby incorporated by reference herein in its entirety.

What is claimed is:

1. An information processing apparatus comprising:
at least one processor or circuit and a memory storing instructions to cause the at least one processor or circuit to perform operations of the following units:
an acquisition unit that acquires a captured image;
a subject detection unit that detects a specific subject registered in advance from the image;
an action detection unit that detects a specific action of a specific subject from the image; and
a management unit that manages information on a specific subject acquired by the acquisition unit,
wherein the management unit records an identifier of a specific subject taking the specific action and a count of recording an image of the specific subject taking the specific action, in a case where shooting of the specific subject taking the specific action is performed.

2. The information processing apparatus according to claim 1, wherein the image is a live view image, and the at least one processor or circuit further functions as a tracking unit that detects and tracks, in a subsequent frame, the specific subject detected by the subject detection unit in a previous frame of the live view image.

3. The information processing apparatus according to claim 2, wherein the at least one processor or circuit further functions as
a control unit that controls a display unit that displays a recording count of an image of the specific subject tracked by the tracking unit.

4. The information processing apparatus according to claim 1, wherein even in a case where the subject detection unit does not authenticate a specific subject in the image as the registered specific subject, in a case where the action detection unit detects the specific action, the management unit records the specific subject as a provisional specific subject, and updates a record as the registered specific subject in a case where the specific subject is authenticated as the registered specific subject in a subsequent frame.

5. The information processing apparatus according to claim 1, wherein the action detection unit detects the specific action based on a posture of a specific subject and an object related to the specific action.

6. The information processing apparatus according to claim 1, wherein the management unit varies a recording method for information to be managed between a case where authentication of the information processing apparatus and detection of the specific action can be performed in a same frame, a case where the specific action is detected first and authentication of a specific subject can be performed in a subsequent frame, and a case where authentication of a specific subject can be performed first and the specific action is detected in a subsequent frame.

7. The information processing apparatus according to claim 1, wherein in a case where a specific subject is recorded as an image, the management unit records a count of recording an image of the specific subject taking the specific action.

8. The information processing apparatus according to claim 1, wherein the management unit facilitates determination that a specific subject with a low count of recording of an image of taking the specific action is taking the specific action.

9. The information processing apparatus according to claim 7, wherein a low count of recording of an image of taking the specific action is a case where the count of recording is smaller than a count of recording set in advance.

10. The information processing apparatus according to claim 7, wherein a low count of recording of an image of taking the specific action is a case of being smaller than an average of a count of recording of an image of taking the specific action for the specific subject registered in advance.

11. The information processing apparatus according to claim 1, wherein the at least one processor or circuit further functions as a notification unit that notifies a user of a count of recording an image of taking the specific action for each specific subject.

12. The information processing apparatus according to claim 11, wherein the notification unit is a display device.

13. The information processing apparatus according to claim 12, wherein the display device displays a count of recording an image of taking the specific action for all the specific subjects registered in advance.

14. The information processing apparatus according to claim 12, wherein the display device displays a specific subject with a low count of recording of an image of taking the specific action at a higher level.

15. The information processing apparatus according to claim 12, wherein the display device emphatically displays a specific subject with a low count of recording of an image of taking the specific action.

16. The information processing apparatus according to claim 15, wherein the display device displays a frame on a specific subject with a low count of recording of an image of taking the specific action.

17. The information processing apparatus according to claim 12, wherein the display device displays a frame for each specific subject and then displays each count of recording an image of taking the specific action.

18. The information processing apparatus according to claim 1, wherein information of the management unit is shared by a plurality of information processing apparatuses.

19. The information processing apparatus according to claim 18, wherein in a case where the plurality of information processing apparatuses share information, the management unit records information on a time when a specific subject takes the specific action.

20. An information processing apparatus comprising:
at least one processor or circuit and a memory storing instructions to cause the at least one processor or circuit to perform operations of the following units:
an acquisition unit that acquires a captured image;
a subject detection unit that detects a specific subject registered in advance from the image;
an action detection unit that detects a specific action of a specific subject from the image; and
a management unit that manages information on a specific subject acquired by the acquisition unit,
wherein the management unit records success or failure of recording an image of taking a specific action for each specific subject.

21. The information processing apparatus according to claim 20, wherein the image is a live view image, and the at least one processor or circuit further functions as a tracking unit that detects and tracks, in a subsequent frame, the specific subject detected by the subject detection unit in a previous frame of the live view image.

22. The information processing apparatus according to claim 21, wherein the at least one processor or circuit further functions as a control unit that controls a display device that displays success or failure of recording an image of the specific subject tracked by the tracking unit.

23. The information processing apparatus according to claim 1, wherein the specific subject is a person.

24. A control method for an information processing apparatus including an acquisition unit that acquires an image of a subject, the control method comprising:
executing subject detection of detecting a specific subject registered in advance from the image;
executing action detection of detecting a specific action of a specific subject from the image; and
executing management of managing information on a specific subject acquired by the acquisition unit,
wherein in the management, an identifier of a specific subject taking the specific action and a count of recording an image of the specific subject taking the specific action are recorded, in a case where shooting of the specific subject taking the specific action is performed.

25. A non-transitory computer-readable storage medium storing a program for causing a computer to execute each step of a control method for an information processing apparatus including an acquisition unit that acquires an image of a subject, the control method comprising:
executing subject detection of detecting a specific subject registered in advance from the image;
executing action detection of detecting a specific action of a specific subject from the image; and
executing management of managing information on a specific subject acquired by the acquisition unit,
wherein in the management, an identifier of a specific subject taking the specific action and a count of recording an image of the specific subject taking the specific action are recorded, in a case where shooting of the specific subject taking the specific action is performed.
